(19) United States
(12) Patent Application Publication
(10) Pub. No.: US 2017/0193757 A1
(43) Pub. Date: Jul. 6, 2017

(54) Method And System For Changing An Amount Of A First Denomination At An Automated Teller Machine

(71) Applicant: MasterCard International Incorporated, Purchase, NY (US)

(72) Inventors: Gurpeet ATWAL, Somers, NY (US); Jaipal Singh KUMAWAT, Sikar (IN); Vipul MEHROTRA, New Delhi (IN)

(21) Appl. No.: 15/392,502

(22) Filed: Dec. 28, 2016

(30) Foreign Application Priority Data
Dec. 30, 2015 (SG) 10201510797W

(51) Int. Cl. G07F 19/00; G06Q 20/40; G06Q 20/10

(52) U.S. Cl. CPC G07F 19/203; G06Q 20/1085; G06Q 20/4014; G07F 19/205

(57) ABSTRACT

A method for changing an amount of a first denomination at an Automated Teller Machine (ATM) includes the steps of authenticating a user based on identification data received from the user at the ATM; receiving, at the ATM, an item in the first denomination when the user is authenticated; determining, at the ATM, the amount of the item received in the first denomination; and determining, at the ATM, at least one second denomination that relates to the determined amount. The at least one second denomination is different from the first denomination. At the ATM, the determined amount of the received item is dispensed in the at least one second denomination.

### CROSS-REFERENCE TO RELATED APPLICATIONS

This application claims foreign priority to Singapore (SG) Application No. 10201510797W filed 30 Dec. 2015, the complete disclosure of which is expressly incorporated herein by reference in its entirety for all purposes.

### FIELD OF INVENTION

The present invention relates broadly, but not exclusively, to methods and systems for changing an amount of a first denomination at an Automated Teller Machine (ATM).

### BACKGROUND

Automatic Teller Machines (“ATMs”) are widely used by customers of financial institutions to perform transactions related to financial accounts. ATMs may be used for a variety of purposes, including the deposit or withdrawal of funds to such financial accounts. ATM's may also be used for credit card cash advances and other transactions, money transfers, payments (e.g., payment of a bill), balance inquiries, item purchase items (e.g., stamps), and other types of transactions involving the making and receiving of payments. One of the most common transactions involves the withdrawal of money from an account.

However, one disadvantage about withdrawing money from the ATM is that currencies expressed in larger denominations are usually dispersed. In order to obtain the currencies expressed in smaller denominations, a user of the ATM often has to buy petty items which are typically useless.

A need therefore exists to provide methods and systems for changing an amount of a first denomination that seek to address at least some of the above problems.

Furthermore, other desirable features and characteristics will become apparent from the subsequent detailed description and the appended claims, taken in conjunction with the accompanying drawings and this background of the disclosure.

### SUMMARY

According to the first aspect of the invention, there is a method for changing an amount of a first denomination at an Automated Teller Machine (ATM). The method comprises the steps of:
authenticating a user based on identification data received from the user at the ATM;
receiving, at the ATM, an item in the first denomination when the user is authenticated;
determining, at the ATM, the amount of the item received in the first denomination;
determining, at the ATM, at least one second denomination that relates to the determined amount, the at least one second denomination being different from the first denomination; and
dispensing, at the ATM, the determined amount of the received item in the at least one second denomination.

In an embodiment, the step of determining, at the ATM, the amount of received item further comprises:
determining, at the ATM, if the received item is fraudulent,
wherein the method further comprises a step of:
sending an external server a message when the received item is determined to be fraudulent.

In an embodiment, the step of determining, at the ATM, the at least one second denomination comprises:
determining the at least one second denomination from a plurality of predefined denominations based on the determined amount.

In an embodiment, the identification data received from the user comprises at least one of: an account number, a unique identifier, and cardholder identification data.

In an embodiment, the at least one second denomination is smaller than the first denomination.

In an embodiment, the item is expressed in at least one of: a monetary currency form, a redemption form and a coupon form.

In an embodiment, the method further comprises capturing, at the ATM, an image of the user when it is determined that the received item is fraudulent.

In an embodiment, the step of authenticating the user based on the identification data comprises:
a. receiving an input at the ATM; and
b. comparing the input and a predetermined password stored in a database having stored therein the plurality of passwords.

According to the second aspect of the invention, there is an Automated Teller Machine (ATM) for changing an amount of a denomination. The ATM comprises a processor and a memory including computer program code; the memory and the computer program code configured to, with the processor, cause the ATM to:
c. authenticate a user based on identification data received from the user at the ATM;
d. receive an item in a first denomination when the user is authenticated;
e. determine, at the ATM, the amount of the item received in the first denomination; determine at least one second denomination that relates to the determined amount, the at least one second denomination being different from the first denomination; and
f. dispense the amount in the at least one second denomination.

According to the third aspect of the invention, a network-based system for changing an amount of a denomination is provided. The system comprises:
g. the ATM as claimed in any one of claims 10 to 16; and
h. a server communicatively coupled to the ATM, the server having stored therein the identification data.

### BRIEF DESCRIPTION OF THE DRAWINGS

Embodiments will be better understood and readily apparent to one of ordinary skill in the art from the following written description, by way of example only, and in conjunction with the drawings, in which:

FIG. 1 shows a schematic diagram illustrating the flow of information in a system 100 for authenticating a process according to an example embodiment.

FIG. 2 shows a flow chart illustrating a method for changing an amount of a first denomination according to an example embodiment.

FIG. 3 shows a flow chart illustrating a method for determining if an item received at the ATM is fraudulent while changing the first denomination according to an example embodiment.

FIG. 4 shows a schematic diagram of an Automated Teller Machine (ATM) for changing an amount of a first denomination according to an example embodiment.

FIG. 5 shows a schematic diagram of a network-based system for changing an amount of a first denomination according to an example embodiment.

FIG. 6 shows a schematic diagram of a computer system suitable for use in an example embodiment.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present invention relate to methods and systems for changing an amount of a first denomination at an Automated Teller Machine (ATM). In an embodiment, the method and system change an amount of a first denomination only when the user is authenticated.

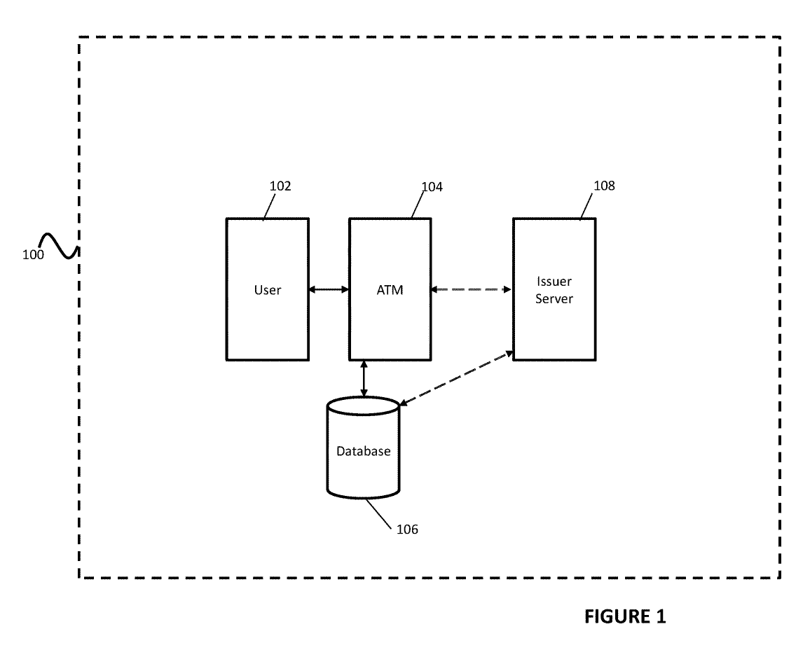

FIG. 1 shows a schematic diagram illustrating the flow of information in a system 100 for authenticating a process according to an example embodiment.

Referring to FIG. 1, provision of the authentication process involves an user 102, an ATM 104, a database 106 and an issuer server 108. The system 100 comprises the ATM 104 in direct communication with the issuer server 108 and the database 106. The ATM 104 may also be in direct communication with the database 106, without having to communicate with the issuer server 108. In specific embodiments, the issuer server 108 may also be in direct communication with the database 106.

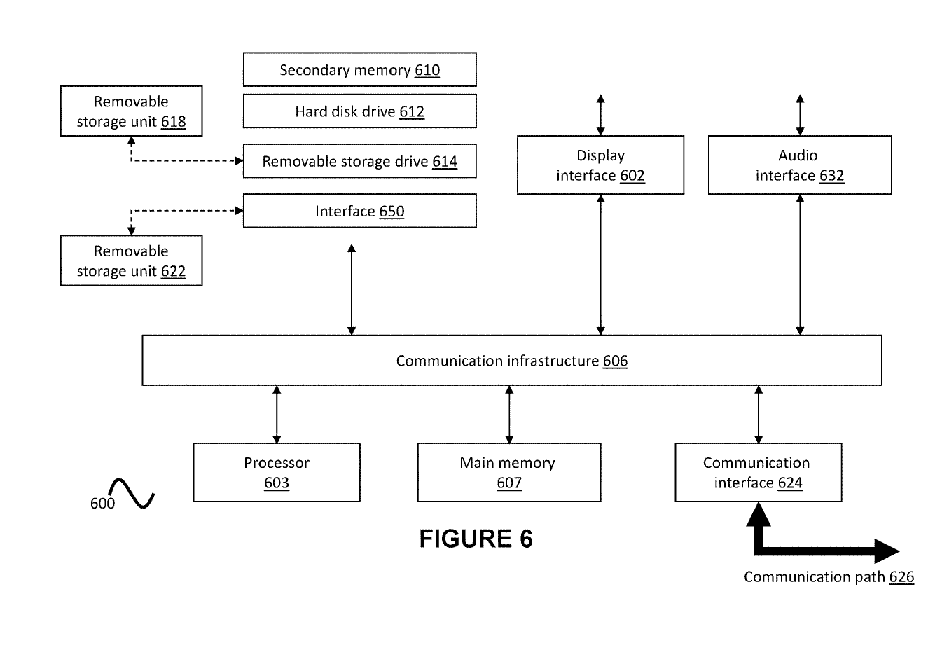

In an embodiment, a ‘server’ may be understood to mean a single computing device or at least one computer network of interconnected computing devices which operate together to perform a particular function. That is, the server may be contained within a single hardware unit or be distributed among several or many different hardware units. An exemplary computing device which may be operated as a server is described below with reference to FIG. 6.

For the purposes of this application, the user 102 is one who uses the ATM 104 to request a process. For the following description, the process refers to, among other things, one which allows the user 102 to change an amount of a first denomination. The amount may be expressed in at least one of a monetary currency form, a redemption form and a coupon form. In an embodiment, the user 102 has to be authenticated before the process may proceed. The step of authenticating an user is a process of verifying if the user is the true holder or true owner of an account provided for use at the ATM.

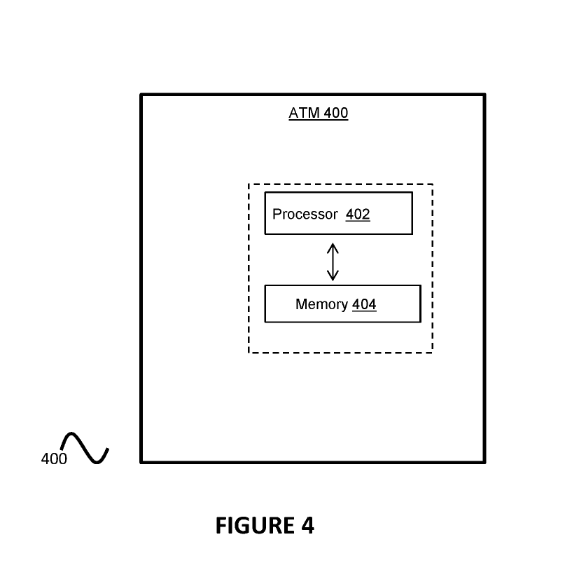

In an embodiment, the ATM 104 may be associated with a payment facilitator (e.g. MasterCard®) who may be an entity (e.g. a company or organization) who operates to process transactions, clear and settle funds for payments between two entities (e.g. two banks). The payment facilitator may be associated with a payment network server. For example, the payment network server 108 may be the Banknet® network operated by MasterCard®. The payment network server 108 may include one or more computing devices that are used for processing transactions. An exemplary ATM 104 is shown in FIG. 4.

The issuer server 108 generally is associated with an issuer and may include one or more computing devices that are used to perform a payment transaction. The issuer may be an entity (e.g. a company or organization) which issues (e.g. establishes, manages, administers) a transaction credential or an account (e.g. a financial bank account). In an embodiment, the ATM 104 may be associated with the issuer.

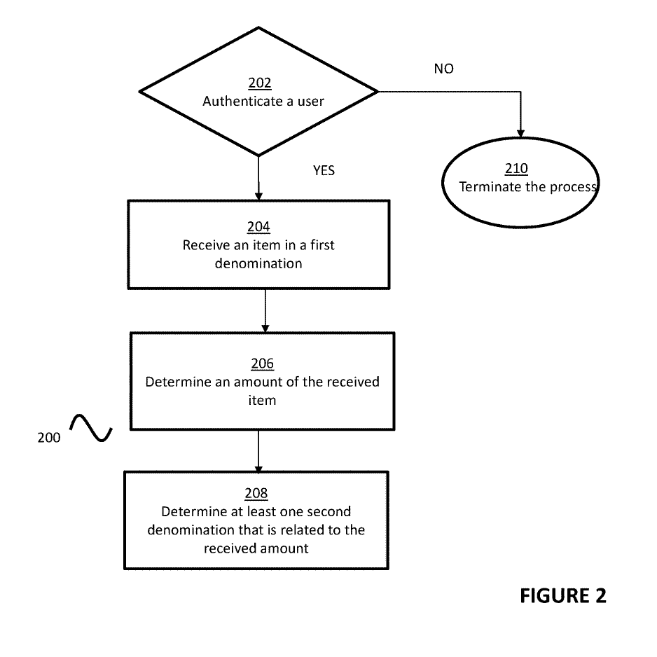

In an embodiment, the ATM 104 is configured to communicate with, or may include, a database 106. The database 106 stores data corresponding to each account. Examples of the data include identification data, an account holder name and address and/or a credit limit. The database 106 may be implemented using a server and/or a cloud-computing storage device. Further details on how this data is managed are described in FIG. 2 below.

FIG. 2 shows a flow chart 200 illustrating a method for changing an amount of a first denomination at an ATM according to an example embodiment.

In FIG. 2, processing begins at step 202. At step 202, a request message is generated at the ATM. In an embodiment, the request message is generated by the user when he makes a request to use the ATM for one of its processes, for example, to make cash withdrawal or to change an amount of a denomination.

The request message may include identification data. The identification data identifies the account indicated by the user to be used in the process. The identification data may include the name of the issuer, cardholder identification data, an unique identifier, the primary account number (or “PAN”) and the date of expiry of the account (if applicable).

The PAN refers to a number of digits (or characters) which identify an account issued by an issuer (for example, a bank). For example, in some embodiments, an account (e.g. credit account, debit account, pre-paid account) is issued by an issuer pursuant to the MasterCard® International Incorporated rules, and the PAN may be a twelve to nineteen-digit string that identifies both the issuer (e.g. which may be based on the first few digits of the string, for example, the first five to ten digits) and the specific account (e.g. which may be based on some or all of the remaining digits). The PAN may also identify if the user is subscribed to a transaction protocol such as a denomination changing service. In an embodiment, the denomination changing service may underlie the authentication programs offered by a payment facilitator (e.g. MasterCard®) to authenticate a user for use of a specific process. In an embodiment, the payment facilitator may charge the user a fee to subscribe to such a process. Additionally or alternatively, the payment facilitator may charge the user a fee to use such a process. The PAN is typically utilized to route and process transactions that involve the account. Those skilled in the art will appreciate that other primary account schemes and formats may be used in conjunction with embodiments described herein.

In specific implementations, the ATM outputs an authentication request message in order to request password data from the user of the ATM. In an embodiment, the ATM includes a display and ATM may be configured to visually present, on the display, the authentication request message for the password data. In an embodiment, the ATM includes a speaker and the ATM may be configured to audibly present the authentication request message for the password data via the speaker.

The ATM is configured to receive the input from a user of the ATM in response to outputting the authentication request message. In an embodiment, the input may be entered using an input device of ATM. In an embodiment, the input device is a keyboard, a keypad or a touch screen. It should be understood that various forms of the input devices may be used, such as biometric readers that may be operative to receive user identifying inputs such as fingerprints, iris scans, retina scans, and face topography data that provide data that is usable to identify a user. Other input devices such as speech or voice recognition devices, inductance type readers, IR type readers, and other types of devices which are capable of receiving information that identifies a user and/or their account may also be used.

Upon receiving the input from the user, the ATM sends the input to an issuer server. In an embodiment, the ATM forwards the received input to the issuer server without processing the input. In another embodiment, the ATM may perform further processing to the input, for example by changing the format of the input, before the input is sent to the issuer server.

In specific implementations, the issuer server generates an authentication response message. The issuer server may generate the authentication response message in response to receiving the input. In an embodiment, a password stored as authentication data may be pre-set or registered by the holder of the account with the issuer. The password corresponding to the account may be stored in the database which is part of, or is in communication with, the issuer server.

Upon receiving the input forwarded by the ATM, the issuer server is further configured to compare the input received at the ATM with the password identified in the authentication data. In other words, the issuer server may determine that the holder of the account is the user at the ATM if the input received at the ATM matches or corresponds to the password identified by the authentication data. For example, the authentication request message may request that a complete password be entered. If so, the input is then compared by the issuer server to the complete pre-set or registered password. On the other hand, the authentication request message may request that the first, third and sixth characters of the password be input. In this case, the input is then compared by the issuer server to the appropriate portions of the pre-set or registered password. In an embodiment, an indication, which is based on the comparison between the input and a password associated with the account, is included in the authentication response message. The indication is used to indicate whether the holder of the account is the user at the ATM.

For example, the indication may be “Y” or “Yes” if the input matches or corresponds to the password identified in the verification data. The indication may be “N” or “No” if the input does not match or correspond to the password identified in the verification data. The indication may be “U” or “Un-contactable” if no input has been received at the verification device.

In an embodiment, the issuer server may authenticate the indication by including a certificate in the authentication request message. In an embodiment, the certificate may be a signature belonging to the issuer server. The certificate may be used to confirm that the indication is provided by the issuer. In this way, a recipient (e.g., the ATM) of the certificate provided in the authentication request message may be informed that the indication is rightfully included by the issuer via the certificate, i.e. that the indication is authentic.

In an embodiment, the authentication request message includes the indication. In another embodiment, the authentication request message includes the indication and the certificate. The issuer server then sends the authentication response message to the ATM. In other words, the issuer server sends the authentication response message to inform the ATM if the holder of the account is likely to have initiated the transaction.

The ATM receives the authentication response message from the issuer server and determines whether to proceed with the requested process (e.g., to change the denomination of the currency). In specific embodiments, the ATM will only authorize the requested process when the authentication response message indicates that the holder of the account is the user, e.g. the indication is “Y”. In other words, the ATM will not authorize the requested process when the authentication response message does not indicate that the holder of the account is the user, e.g. the indication is “N” or “U”. In specific implementations, the database is updated of every message that is exchanged between the ATM and the issuer server.

The authentication process described above involves multiple parties (e.g., the issuer and the payment facilitator). However, the authentication process may be essentially viewed as an operation between a user and the issuer (with the payment facilitator facilitating the transaction). Alternatively, the authentication process may be viewed as an operation between a user and the payment facilitator (without the involvement of an issuer). In such implementations, the database is updated of every message that is exchanged between the user and the ATM, and the payment facilitator is capable to perform the operations performed by the issuer server (e.g., sending an authentication response message).

Following step 202, step 204 is performed when the user is authenticated. That is, the ATM is configured to receive an item in a first denomination when the authentication response message indicates that the user at ATM is the holder of the account. In an embodiment, the item may be received at the ATM via an input means. In an embodiment, the input means is inlet slot or a pull-out drawer.

As stated in the foregoing, the PAN indicated in the identification data may identify if an account holder is a subscriber to a specific process, for example, a process that allows the account holder to change an amount of a denomination. In an embodiment, the step of authenticating is one that includes determining whether or not the account holder is a subscriber to the specific process. In other words, the ATM will not proceed to request a password data from the user.

However, in another embodiment, the process of changing the denomination may be carried out even if the authentication response message does not indicate that the holder of the account is the user at the ATM, e.g. the indication is “N” or “U”. For example, the issuer server may determine the type of the account (based on the identification data) if the authentication response message does not indicate that the holder of the account is the user at the ATM. For example, if the account is a privileged type, the issuer may proceed to authorize the process at its own discretion if the input received at the ATM does not correspond to the password identified in the authentication data (i.e. the indicator is “No” or “Un-contactable”).

Following step 202, step 210 is performed when the user is not authenticated in an embodiment. That is, the ATM is configured to terminate the process and wait for the next process when the authentication response message indicates that the user at the ATM is not the true account holder.

In step 206, the ATM determines an amount of the received item after the user has been authenticated. In an embodiment, the item may be a monetary currency, a redemption coupon or a promotion coupon. In an embodiment, step 206 includes detecting a detectable property of one or more forms of the received item when the received item is within a predetermined distance of the inlet slot so as to determine an amount of the item.

The user is provided with an option to change a denomination of the determined amount. That is, in one embodiment, the ATM provides the opportunity to insert a currency (e.g., an item) expressed in a first denomination (e.g., $100) to be changed into a currency expressed in a second denomination. The ATM determines an amount of the item to be $100 before it proceeds to step 206.

At step 206, the ATM determines at least one second denomination that relates to the received amount. The at least one second denomination is different from the first denomination. The ATM is configured to do a check on its storage to determine an amount of currencies stored in a plurality of denominations. Once the ATM has determined that it has sufficient currencies in the various denominations, it determines a suitable denomination to change the first denomination into. The at least one denomination is determined from a plurality of predefined denominations based on the determined amount, on the condition that the determined amount in the first denomination will remain the same as an amount to be dispensed at the ATM.

In a first scenario, the user arrives at the ATM and inputs a monetary note after he has been authenticated. The ATM determines an amount of the monetary note to be $10. Based on the determined amount of $10, the ATM checks its storage to determine if it has sufficient amount of currencies expressed in the plurality of predefined denominations. In this scenario, the plurality of predetermined denominations includes $5 notes and $2 notes. The ATM checks to find out if it has 5 pieces of $2 notes and/or 2 pieces of $5 notes. In the event that the ATM determines that it has 5 pieces of $2 notes and 2 pieces of $5 notes, a message will be displayed on the ATM to offer the option of changing the $10 into 5 pieces of $2 notes or 2 pieces of $5 notes. In the event that ATM determines that it only has 4 pieces of $2 notes but 2 pieces of $5 notes, a message will be displayed on the ATM to offer the only option of changing the $10 into 2 pieces of $5 notes.

In a second scenario, the user arrives at the ATM and inputs a monetary note after he has been authenticated. The ATM determines an amount of the monetary note to be $100. Based on the determined amount of $100, the ATM checks its storage to determine if it has sufficient amount of currencies expressed in the plurality of predefined denominations. In this scenario, the plurality of denominations includes $2 notes, $5 notes, $10 notes, $20 notes, $50 notes and $100 notes. The ATM checks to find out if it has 50 pieces of $2 notes and/or 20 pieces of $5 notes and/or 5 pieces of $20 and/or 10 pieces of $10 and/or 2 pieces of $50 and/or 5 pieces of $20. In the event that the ATM determines that it has 5 pieces of $2 notes and 2 pieces of $5 notes, a message will be displayed on the ATM to offer, among other possible combinations, the option of changing the $100 into:
(i) 50 pieces of $2 notes or
(ii) 20 pieces of $5 notes or
(iii) 2 pieces of $50 notes or
(iv) 10 pieces of $10 notes or
(v) 5 pieces of $20 notes or
(vi) 40 pieces of $2 notes and 2 piece of $10 note or
(vii) 40 pieces of $2 notes and 1 piece of $20 note.

Once the user makes a selection of the options indicated in the message displayed on the ATM, the ATM dispenses, at an output means, the amount in the at least one second denomination. The output means may be the same as or different from the input means. Following the first scenario, the $10 note that is input into the ATM may be dispensed in 5 pieces of $2 note. That is, the at least one second denomination is $2. The received amount expressed in the first denomination (e.g., $10 note) is the same as the dispersed amount (e.g., 5 pieces of $2 note). Following the second scenario, the $100 note that is input into the ATM may be dispersed in 40 pieces of $2 notes and 2 pieces of $10 notes. That is, the at least one second denomination includes $2 notes and $10 notes.

It can be seen from the above two scenarios that the at least one second denomination includes one other denomination. The above two scenarios show that a currency expressed in a first denomination may be changed into a currency expressed in a smaller denomination. Additionally or alternatively, embodiments of the inventions also allow a currency expressed in a first denomination to be changed into another currency expressed in a larger denomination. For example, it is possible for the user to input five pieces of $2 notes to obtain a piece of $10 notes or two pieces of $5 notes.

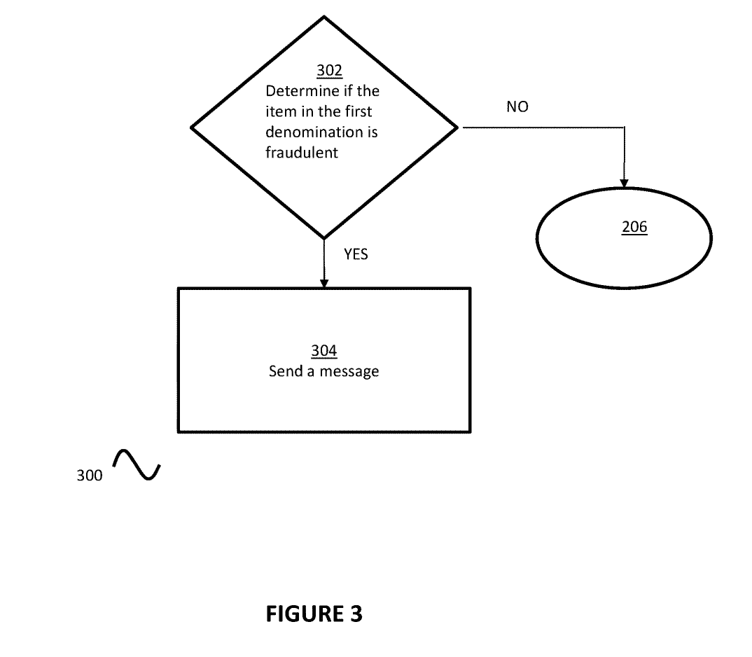

In an embodiment, the ATM is configured to perform operations as illustrated in FIG. 3. FIG. 3 shows a flow chart 300 illustrating a method for determining if an item expressed in the first denomination is fraudulent according to an example embodiment.

In FIG. 3, processing begins at step 302 after receiving the item in the first denomination in step 204. At step 302, the ATM determines if an item received in the first denomination is fraudulent. In an embodiment, step 302 includes detecting a detectable property of one or more forms of the item when the item is within a predetermined distance of the inlet slot. The ATM may be configured to compare the detected detectable property with a predetermined correct property of a genuine item of the same denomination or form.

In step 304, the ATM is further configured to send a message to an external server (e.g., a payment network server belonging to the payment facilitator or an issuer server) if the item expressed in the first denomination is determined to be fraudulent. In an embodiment, the item expressed in the first denomination is determined to be fraudulent if the detectable property of the received item does not match the predetermined correct property of the genuine item of the same denomination or form of the item being detected. Examples of the item, among other examples, include coins, notes, or any piece of paper that holds value and includes a detectable property. That is, the ATM may also be configured to detect an authenticity of a valuable object, wherein a valuable object may be any redemption ticket, promotion ticket, or coupon ticket that has a value, wherein value is measured by monetary standards or personal importance. Examples of detectable property, among other examples, include a trait, property, portion, inclusion, omission, symbol, design, EMR frequency, magnetic field, radio frequency, stain, unique identifier, material, weight, thickness, and the like, of the currency, marks only visible under certain light, and the like, that is either inherent, made with, attached, embedded, and/or identifiable with the currency. In an embodiment, an image of the user is captured if the item expressed in the first denomination is determined to be fraudulent. In an embodiment, the ATM may return the fraudulent item to the user.

Following step 302, step 206 is performed if the item expressed in the first denomination is determined to be not fraudulent.

FIG. 4 shows the schematic diagram of an Automated Teller Machine (ATM) 400 for changing an amount of a first denomination in an example embodiment. The ATM 400 comprises a processor 402 and a memory 404 including computer program code. The memory 404 and the computer program code is configured to, with the processor 402, cause the ATM 400 to: authenticate a user based on identification data received from the user at the ATM; receive an item in a first denomination when the user is authenticated; determine the amount of the item received in its first denomination; determine at least one second denomination that relate to the received amount, the at least one denomination being different from the first denomination; and dispense the amount in the at least one second denomination. The ATM 400 is further caused to store in a database, the authentication data pre-set or registered with an account holder and/or at least one message that is exchanged between the user and the ATM that is described in FIG. 2.

The ATM 400 typically includes hardware such as a numeric keypad for input of the user's PIN, function keys and a display device for displaying a graphical user interface (GUI) to select the at least one second denominations presented to the user. A touch screen interface may also be provided to replace the numeric keypad and function keys. A magnetic stripe or chip card reader may also be provided to read identification data encoded on the card in order to identify the user. In other examples, the ATM 400 may also include a biometric device which serves as a security identification and authentication device that measures unique physical characteristics (biometrics) such as fingerprints, facial image, iris print or voice of a human being to establish their unique identity. Examples of biometric devices include fingerprint readers, facial recognition systems, voice verification systems, hand geometry systems, signature verification systems and iris recognition systems. In other embodiments, the ATM 400 may a detection device proximate the input means. The detection device includes at least one scanning device for detecting a detectable property of one or more forms of item when the item is within a predetermined distance of the at least one scanning device. The detection device in the ATM 400 may be configured to compare the detected detectable property with a predetermined correct property of a genuine item of the same denomination or form. Examples of a detection device may be an individual unit, either operably coupled to or physically separate from the ATM.

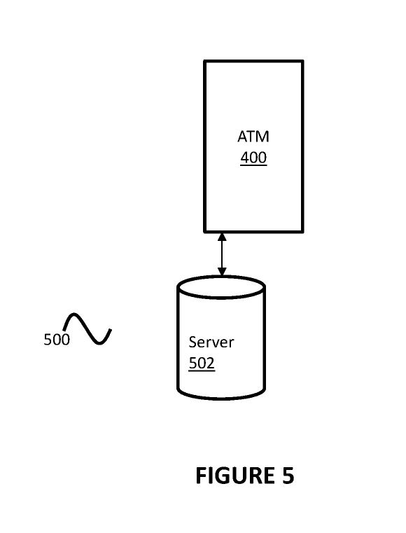

FIG. 5 shows the schematic diagram of a network-based system 500 for changing an amount of a first denomination in an example embodiment. The system 500 comprises the ATM 400 as depicted in FIG. 4 and a server 502 communicatively coupled to the ATM 400. The server 502 stores the authentication data associated with the account holder.

FIG. 6 depicts an exemplary computing device 600, hereinafter interchangeably referred to as a computer system 600, where one or more such computing devices 600 may be used to (at least partially) implement the ATM 400. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a hard disk drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage unit 618 in a well-known manner. The removable storage unit 618 may include magnetic tape, optical disk, non-volatile memory storage medium, or the like, which is read by and written to by removable storage drive 614. As will be appreciated by persons skilled in the relevant art(s), the removable storage unit 618 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 620. Examples of a removable storage unit 622 and interface 620 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 620 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port (such as a serial, parallel, printer, GPIB, IEEE 1394, RJ45, USB), an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage unit 618, removable storage unit 622, a hard disk installed in hard disk drive 612, or a carrier wave carrying software over communication path 626 (wireless link or cable) to communication interface 624. Computer readable storage media refers to any non-transitory tangible storage medium that provides recorded instructions and/or data to the computing device 600 for execution and/or processing. Examples of such storage media include magnetic tape, CD-ROM, DVD, Blu-ray™ Disc, a hard disk drive, a ROM or integrated circuit, a solid state drive (such as a USB flash drive, a flash memory device, a solid state drive or a memory card), a hybrid drive, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the hard disk drive 612, or the interface 620. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated that the elements illustrated in FIG. 6 function to provide means for performing the various functions and operations of the servers as described in the above embodiments.

By changing a denomination of an amount at an ATM, users do not have to buy unwanted petty items in order to get currency in smaller denominations. Similarly, users are also given an option to change the currency into a larger denomination. Advantageously, this allows users to carry lesser notes around. Embodiments of the invention also provide solutions to determine the authenticity of the currency which eliminate the possibility of circulating counterfeit currency around. Also, it allows the authority (e.g., the issuing bank) to be informed of the person who is using such a counterfeit currency. Further advantageously, embodiments allow providers providing the service to charge for providing the service.

It will be appreciated by a person skilled in the art that numerous variations and/or modifications may be made as shown in the specific embodiments without departing from the spirit or scope of the invention as broadly described. The present embodiments are, therefore, to be considered in all respects to be illustrative and not restrictive.

What is claimed is:

1. A method for changing an amount of a first denomination at an Automated Teller Machine (ATM), the method comprising the steps of:
authenticating a user based on identification data received from the user at the ATM;
receiving, at the ATM, an item in the first denomination when the user is authenticated;
determining, at the ATM, the amount of the item received in the first denomination;
determining, at the ATM, at least one second denomination that relates to the determined amount, the at least one second denomination being different from the first denomination; and
dispensing, at the ATM, the determined amount of the received item in the at least one second denomination.

2. The method according to claim 1, wherein the step of determining, at the ATM, the amount of received item further comprises:
determining, at the ATM, if the received item is fraudulent,
wherein the method further comprises a step of:
sending an external server a message when the received item is determined to be fraudulent.

3. The method of according to claim 2, further comprising capturing, at the ATM, an image of the user when it is determined that the received item is fraudulent.

4. The method according to claim 1, wherein the step of determining, at the ATM, the at least one second denomination comprises:
determining the at least one second denomination from a plurality of predefined denominations based on the determined amount.

5. The method according to claim 1, wherein the identification data received from the user comprises at least one of: an account number, a unique identifier, and cardholder identification data.

6. The method according to claim 1, wherein the at least one second denomination is smaller than the first denomination.

7. The method according to claim 1, wherein the item is expressed in at least one of: a monetary currency form, a redemption form and a coupon form.

8. The method according to claim 1, wherein the step of authenticating the user based on the identification data comprises:
receiving an input at the ATM; and
comparing the input and a predetermined password stored in a database having stored therein the plurality of passwords.

9. An Automated Teller Machine (ATM) for changing an amount of a denomination, the ATM comprising a processor and a memory including computer program code; the memory and the computer program code configured to, with the processor, cause the ATM to:
authenticate a user based on identification data received from the user at the ATM;
receive an item in a first denomination when the user is authenticated;
determine, at the ATM, the amount of the item received in the first denomination; determine at least one second denomination that relates to the determined amount, the at least one second denomination being different from the first denomination; and
dispense the amount in the at least one second denomination.

10. The ATM according to claim 9, wherein the memory and the computer program code are further configured with the processor to:
determine if the received item is fraudulent; and
send an external server a message when the received item is determined to be fraudulent.

11. The ATM according to claim 9, wherein the memory and the computer program code are further configured with the processor to:
determine the at least one second denomination from a plurality of predefined denominations based on the determined amount.

12. The ATM according claim 9, wherein the identification data received from the user comprises at least one of: an account number, a unique identifier, and cardholder identification data.

13. The ATM according to claim 9, wherein the at least one second denomination is smaller than the first denomination.

14. The ATM according to claim 9, wherein the item is expressed in at least one of: a monetary currency form, a redemption form and a coupon form.

15. The ATM according to claim 14, wherein the memory and the computer program code are further configured with processor to:
capture an image of the user when it is determined that the received item is fraudulent.

16. The ATM according to claim 15, wherein the memory and the computer program code are further configured with the processor to:
receive an input at the ATM; and
compare the input and a predetermined password stored in a database having stored therein a plurality of passwords.

17. A network-based system for changing an amount of a denomination, the system comprising:
an Automated Teller Machine (ATM) for changing an amount of a denomination, the ATM comprising a processor and a memory including computer program code; the memory and the computer program code configured to, with the processor, cause the ATM to:
authenticate a user based on identification data received from the user at the ATM;
receive an item in a first denomination when the user is authenticated;
determine, at the ATM, the amount of the item received in the first denomination; determine at least one second denomination that relates to the determined amount, the at least one second denomination being different from the first denomination; and
dispense the amount in the at least one second denomination; and
a server communicatively coupled to the ATM, the server having stored therein the identification data;
wherein the memory and the computer program code are further configured with the processor to:
determine if the received item is fraudulent; and
send the server a message when the received item is determined to be fraudulent.
